(19) United States
(12) Patent Application Publication
(10) Pub. No.: US 2006/0174500 A1
(43) Pub. Date: Aug. 10, 2006

(54) Center-marking carpentry layout square

(76) Inventor: Kenneth John Knirck, Chico, CA (US)

Correspondence Address: Kenneth J. Knirck, 2053 Marilyn Dr., Chico, CA, 95928, US

(21) Appl. No.: 11/054,077

(22) Filed: Feb. 10, 2005

(51) Int. Cl. B43L 13/02

(52) U.S. Cl. 33/42

(57) ABSTRACT

The device described is a carpenter's framing square, which utilizes an opening located on the centerline of the blade. This centering window allows the user to place the 1½″ wide blade on the centerline of a layout mark in order to strike parallel edge marks to locate a framing stud on the top/bottom plates of a stud wall.

### CROSS-REFERENCE TO RELATED APPLICATIONS

None

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

None

### BACKGROUND OF THE INVENTION

This application is pursuant to Provisional Application No. 60/542682 which was received in the U.S.P.T.O. on Feb. 9, 2004.

### FIELD OF THE INVENTION

This invention relates to the field of carpentry, specifically to aid the user in measuring, marking, and laying out on-center layout lines.

### BRIEF SUMMARY OF THE INVENTION

Carpenters are frequently required to layout stud locations on the top and bottom plates of a stud wall. Typically the edge of the first stud is placed flush with the end of the top and bottom plates. The center of the second stud is located 16″ (or another specified distance) from the end of the plate. Each successive stud is located 16″ on center from the center of the previous stud. A stud wall is laid out in this manner to allow the 48″ wide sheathing such as exterior siding and interior drywall to be nailed to the studs at 16″ intervals. The first and second studs are placed 16″ apart from edge to center respectively to allow the edge of the sheathing material to align with the edge of the stud wall.

This type of layout is usually done using a tape measure and a framing square. The framing square has a blade that is 1½″ wide to correspond to the thickness of a stud. To lay out a stud wall in this fashion, the carpenter will align the edge of the framing square blade to the end of the top/bottom plate of the wall. He will then strike a mark from the opposite edge of the blade. This will mark the width of the stud from the end of the plate. He will then measure from the end of the plate 16″ and mark the center of the second stud. From that mark he must measure ¾ on either side of the center mark to indicate where the edges of the stud should be. Then the third and all remaining studs are measured and marked in a similar fashion until each of the remaining studs are laid out 16″ on center.

The device shown is a typical framing square in that it has a handle and a perpendicular 1½″ wide blade for marking the width of a stud or framing member. However, the device shown utilizes a hole or centering window, which is located on the centerline of the blade. This hole allows the user to place the framing square on a center marked top/bottom plate and mark the edges of the stud without the need to measure the ¾″ half-width of the stud to mark the edge location of each stud. Using this device, the aforementioned method for laying out a stud wall is greatly simplified. Using the improved framing square shown, the carpenter uses his measuring tape to measure and mark the 16″ centers of the studs from the edge of the plate. Then the blade of the improved framing square is placed on the plate so the center mark is located in the centering window of the square. Then the edges of the studs can be marked without the need to measure the ¾″ half-width from the center mark.

### BREIF DESCRIPTION OF THE SEVERAL VIEWS OF THE DRAWING

FIG. 1 is a front view of the device.

FIG. 2 is a side view of the device.

FIG. 3 is an end view of the device.

### DETAILED DESCRIPTION OF THE INVENTION

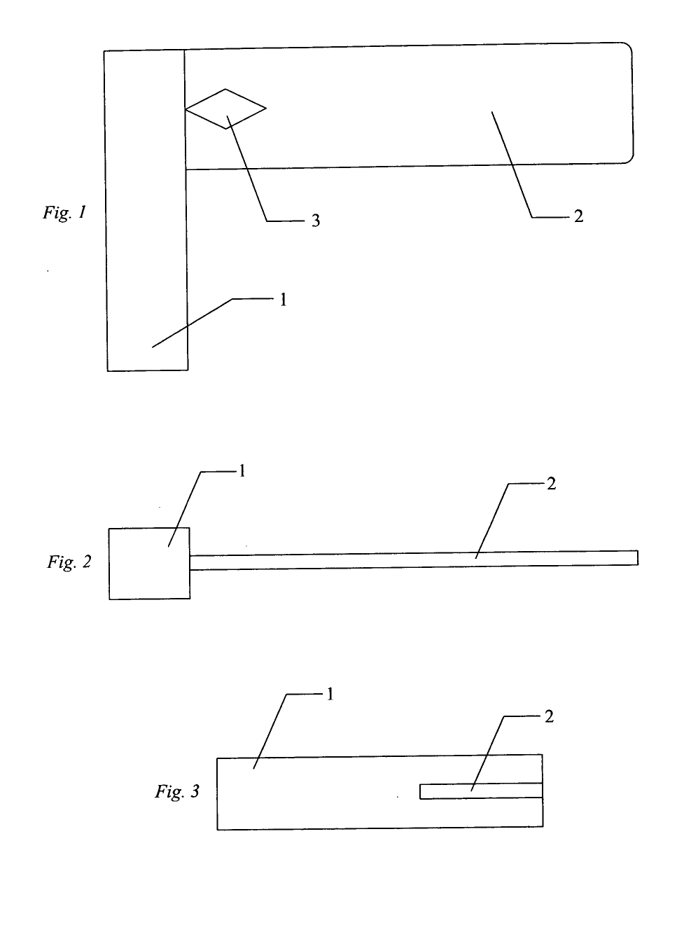

FIGS. 1, 2, and 3 show the component parts of the device. The device is comprised of the handle (1), the blade (2), and the centering window of the blade (3). Like a typical framing square, the handle of the device is placed along the edge of a top/bottom plate of a stud wall. The framing square blade, which is perpendicular to the handle, lays flat against the plate. The width of the blade is 1½″ to correspond to the width of a framing member or stud. By utilizing the device shown, the user can locate the center-marked location of a stud in the center of the centering window. The user can then strike layout marks from the two parallel edges of the blade to indicate the edges of the stud and where it should be located.

### PRIOR ART

None of the current art that is related to the field of framing and/or layout squares utilizes the unique feature of the device described in this application, namely a center-line slot or viewing area that may be used to find or mark the center reference point of a framing member.

### CONCLUSION

The device described is a carpenter's framing square, which utilizes an opening located on the centerline of the blade. This opening or centering window allows the user to place the 1½ wide blade on the centerline of a layout mark in order to strike parallel edge marks to locate a framing stud on the top/bottom plates of a stud wall. The device should be constructed of a rigid and durable material such as metal or high-impact plastic. The centering window should be located near the handle of the square and directly on the centerline of the blade. The window opening should be shaped in a manner that allows the user to easily locate the center mark in the window and give the user good visual cues so the center mark can be placed in the center of the window. A diamond-shaped window, or a round window with notches that are centered at the top and bottom of the round hole are recommended. The window should be sized in a manner that allows the user to easily view an existing centerline mark or to make a mark through the window using a typical flat carpenter's pencil.

I claim:

1. A carpentry framing square that utilizes a centering window in the blade of the framing square that may be used to locate and mark the center reference location of a framing member.

2. Said centering window should be located on the centerline of the 1½″ wide framing square blade.

3. Said centering window should be sized so as to allow the user to easily view an existing centerline mark.

4. Said centering window should be shaped to afford the user adequate visual cues to draw a reference mark that is roughly parallel to the edges of the framing square blade.
